(19) United States
(12) Patent Application Publication
(10) Pub. No.: US 2007/0088908 A1
(43) Pub. Date: Apr. 19, 2007

(54) METHOD FOR ARRANGING HEAP MEMORY

(75) Inventor: Jung-Wei Chen, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/163,358

(22) Filed: Oct. 17, 2005

(51) Int. Cl. G06F 12/00

(52) U.S. Cl. 711/104; 711/170

(57) ABSTRACT

The present invention discloses a method for arranging heap memory. The method is to utilize a memory-management function library positioned in the run-time library for use during run time and designate two sets of heap memory, wherein one set of heap memory is arranged in a dynamic random access memory (DRAM) whereas the other set of heap memory is arranged in a static random access memory (SRAM). In addition, an application program interface is added to indicate a start point and size of the heap memory. Furthermore, a parameter is added to the application program interface for calling one set of heap memory when allocating memory. By doing so, the programmer can select a position to allocate the memory according to the executable content. Therefore, when the processor is executing calculation or accessing memory, the efficiency can be well enhanced.

### BACKGROUND OF THE INVENTION

1. The Field of the Invention

The present invention is to provide a method for arranging heap memory and, more particularly, to arrange two designated sets of heap memory so that a programmer may select a position for allocating the random access memory (RAM) according to the executable content, thereby enhancing efficiency of the processor when the processor is executing calculation or accessing heap memory.

2. Description of Related Art

Computer technology is known to be a fast-changing technology, and to keep up with such fast growing pace, a computer system has to be very powerful in calculation ability and fast in processing speed to meet the demand of computer technology. Therefore, a heap memory is often provided in a computer system for dynamically allocating and releasing objects at run time. Moreover, when a computer system is processed by a central processing unit, the heap memory is often allocated to a dynamic random access memory (DRAM) or synchronous random access memory (SRAM) for use. On the other hand, a built-in static random access memory (SRAM) is employed as a cache memory. If an operating system, such as Windows or Linux, is executed and accessed by a central processing unit, the cache memory may be powerful enough to handle random accessing. However, if the central processing unit is a digital signal processor or microprocessor, the programs executed and data accessed by the processor will be more fixed than those of other processors, and the system clock frequency of the processor will be lower than that of other processors as well. Consequently, when the data to be calculated is placed into a DRAM operated by a digital signal processor or microprocessor for calculation, data accessing between the processor and the DRAM will become very time-consuming because DRAM has to take many times of bus cycles to read out or store in a single data. As a result, time spent for calculation processing may become long and in turn may reduce efficiency of overall system performance. To cope with such problem, one solution is suggested; that is, the heap memory may be placed in the SRAM and used as the cache memory. By doing so, only one time of the bus cycle will be required to read out or store in a single data and thus the overall performance can be enhanced. However, despite that the solution may enhance the processing speed, the solution remains very limited in its application because SRAM is too small to satisfy the need of dynamically allocating memory. In other words, the solution is not a preferable one.

### SUMMARY OF THE INVENTION

The present invention has been accomplished under the circumstance in vies. The object of the present invention is to utilize a memory-management function library positioned in a run-time library for use during run time and designate two sets of heap memory, wherein one set of heap memory is arranged in a dynamic random access memory (DRAM) whereas the other set of heap memory is arranged in a static random access memory (SRAM); besides, a parameter is added to the application program interface for calling one set of heap memory when allocating the memory; therefore, the programmer can select a position to allocate the memory according to the executable content, thereby enhancing efficiency of a processor when the processor is executing calculation or accessing memory.

To achieve the aforementioned object, the present invention first designates two sets of heap memory from a memory-management function library positioned in a run-time library during run time; one set of heap memory is arranged in a DRAM, whereas the other set of heap memory is arranged in a SRAM; in addition, an application program interface is provided for the programmer to define a start point and size of the heap memory, and the programmer can further rewrite the application program interface for allocating and releasing the memory so that the rewritten program can be in accordance with the two sets of heap memory defined by the memory-management function library positioned in the run-time library during run time; thus, according to the executable content of the programmer's designed program, the programmer can select one of the two sets of heap memory defined by the memory-management function library at run time for allocating the RAM, thereby enhancing efficiency of a processor when the processor is executing calculation or accessing heap memory.

### DETAILED DESCRIPTION OF THE PREFERRED EMBODIMENTS

In program setting, the present invention first designates two sets of heap memory from a memory-management function library positioned in a run-time library during run time as below.

typedef enum;
{;
MEM_SRAM = 0;
MEM_DRAM = 1;
} TMemType.

Thus, two sets of heap memory may be designated from the memory-management function library positioned in the run-time library during run time, wherein one set of heap memory is arranged in a dynamic random access memory (DRAM) whereas the other set of heap memory is arranged in a static random access memory (SRAM).

Next, an application program interface will be added as following.

void mem_init (void*sram_addr, int sram_size, void*dram_addr, int dram_size).

The application program interface is provided for the programmer to define a start point and size of each set of heap memory and to reserve the two sets of heap memory in a memory map of a linker.

Next, to modify the allocation and release of memory in the application program as below.

void*my_malloc (int size, TMemType type);

void my_free (void*buf).

The modification “void*my_malloc” differs from the conventional method in that the parameter “TMemType” added to the “void*my_malloc” is to indicate which one of the two sets of heap memory will be selected for use. On the other hand, according to the address that has been transmitted in, the “void my_free” can determine which set of heap memory is used and released.

Therefore, when an operating system contains both DRAM and SRAM that represent different properties, a programmer who applies the system may store massive amount of data in the heap memory selected by the DRAM. Meanwhile, the programmer may also apply the heap memory selected by the SRAM as a register, thereby enhancing efficiency of the processor when a processor is executing calculation or accessing the heap memory.

Alternatively, the DRAM can be a synchronous dynamic random access memory (SDRAM) or double data rate synchronous dynamic random access memory. Likewise, the SRAM can alternatively be a single access random access memory (SARAM) or dual access random access memory (DARAM).

Also, to further explain technical contents and features of the present invention, a multimedia player that is playing an MP3 music file will be used as an embodiment. However, the multimedia player does not limit the spirit and scope of the present invention. When the multimedia player is playing an MP3 music file, the read-out data from the file will be placed in the heap memory selected by the DRAM, and then a first audio frame (occupies only 1 KB) will be extracted from the heap memory of the DRAM and placed into the heap memory selected by the SRAM for decoding calculation. Through this processing method, certain calculation method included in the MP3 decoding calculation, such as modified discrete cosine transform (MDCT), can save DRAM accessing time since time spent for repeatedly reading DRAM can be largely reduced, thereby enhancing efficiency of the decoding calculation.

In conclusion, to improve the technique of prior arts, the method for arranging heap memory according to the present invention is to utilize the memory-management function library positioned in the run-time library during run time to designate two sets of heap memory. Then, one set of heap memory is arranged in the DRAM, whereas the other set of heap memory is arranged in the SRAM. Besides, an application program interface is added in for a programmer to indicate the start point and size of the heap memory. Also, a parameter is added to the application program interface for calling one set of heap memory when allocating DRAM. Moreover, another parameter “TMemType” is added to the memory allocating and releasing program positioned in the application program interface to decide which set of the two sets of heap memory to be applied for memory allocation. Hence, a programmer can select a position for allocating the memory according to the executable content, thereby enhancing efficiency of the processor when the processor is executing calculation or accessing heap memory.

What is claimed is:

1. A method for arranging heap memory, which is to utilize a memory-management function library positioned in a run-time library during run time and designate two sets of heap memory, wherein one set of heap memory is arranged in a dynamic random access memory (DRAM) whereas the other set of heap memory is arranged in a static random access memory (SRAM); besides, an application program interface is added to indicate a start point and size of the heap memory as well as to select a position for allocating the memory according to the executable content, thereby enhancing efficiency of a processor when the processor is executing calculation or accessing memory.

2. The method for arranging heap memory according to claim 1, wherein a parameter is further provided in the application program interface to determine which one of the two sets of heap memory to be applied for use.

3. The method for arranging heap memory according to claim 1, wherein the random access memory (DRAM) can be a synchronous dynamic random access memory (SDR SDRAM).

4. The method for arranging heap memory according to claim 1, wherein the random access memory (DRAM) can be a double data rate synchronous dynamic random access memory (DDR SDRAM).

5. The method for arranging heap memory according to claim 1, wherein the static random access memory (SRAM) can be a single access random access memory (SARAM).

6. The method for arranging heap memory according to claim 1, wherein the static random access memory (SRAM) can be a dual access random access memory (DARAM).
